(19) United States
(12) Patent Application Publication
(10) Pub. No.: US 2026/0089528 A1
(43) Pub. Date: Mar. 26, 2026

(54) DATA REPORTING FOR DATA COLLECTION

(71) Applicant: Lenovo (United States) Inc., Morrisville, NC (US)

(72) Inventors: Joachim Löhr, Wiesbaden (DE); Tapisha Soni, Munich (DE); Vahid Pourahmadi, München (DE)

(73) Assignee: Lenovo (United States) Inc., Morrisville, NC (US)

(21) Appl. No.: 18/891,811

(22) Filed: Sep. 20, 2024

(51) Int. Cl. H04W 24/10; H04W 72/232

(52) U.S. Cl. CPC H04W 24/10; H04W 72/232

(57) ABSTRACT

Various aspects of the present disclosure relate to data reporting for artificial intelligence (AI) in wireless communications. An apparatus, such as a user equipment (UE), generates a report that indicates information associated with data collected in accordance with a first configuration.

The information may include an identifier corresponding to the first configuration and a buffer size associated with an amount of data logged at the UE. The UE may transmit the report to a network equipment (NE). In some examples, the UE may receive control signaling (e.g., downlink control information (DCI)) from the NE indicating a request for at least some of the data associated with the information in the report, where the request includes one or more identifiers corresponding to the at least some of the data. The UE may transmit the requested data to the NE accordingly.

### TECHNICAL FIELD

The present disclosure relates to wireless communications, and more specifically to data reporting (e.g., logging, feedback, communication, transmittal) for artificial intelligence (AI) in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNodeBs (gNBs)), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to generate a report that indicates information associated with data collected in accordance with a first configuration, wherein the information comprises an identifier corresponding to the first configuration and a buffer size associated with an amount of data logged at the UE; and transmit (e.g., output, communicate, send) the report.

In some implementations of the method and apparatuses described herein, the UE receives (e.g., obtains) downlink control information (DCI) indicating a request for at least some of the data associated with the information in the report, wherein the request includes one or more identifiers corresponding to the at least some of the data; and transmits the at least some of the data. In some implementations of the method and apparatuses described herein, the UE receives a plurality of configurations including the first configuration, each configuration associated with an identifier, and wherein the information comprises a plurality of identifiers corresponding to each of the plurality of configurations and the buffer size associated with an amount of data logged at the UE for each of the plurality of configurations.

Additionally, or alternatively, the report is generated based at least in part on the amount of data collected and logged at the UE satisfying a threshold. Additionally, or alternatively, the UE transmits a scheduling request (SR) that requests one or more uplink resources for transmission of the report. Additionally, or alternatively, the UE transmits, via an uplink control channel, a one-bit indication that the data is available for transmission. Additionally, or alternatively, report is transmitted via a logical channel, wherein the logical channel is mapped to more than one SR configuration. In some implementations of the method and apparatuses described herein, the UE prioritizes the information included in the report based at least in part on a priority of each configuration of a plurality of configurations.

Additionally, or alternatively, the information included in the report corresponds to at least one sample of the data based at least in part on a priority of the at least one sample for a given configuration. Additionally, or alternatively, the first configuration is associated with a plurality of configurations, and wherein the plurality of configurations comprises one or more measurement configurations, one or more measurement logging configurations, one or more reporting configurations, or a combination thereof. Additionally, or alternatively, the first configuration is associated with a plurality of configurations, and wherein each configuration of the plurality of configurations is associated with a UE-side condition or an NE-side condition.

Some implementations of the method and apparatuses described herein may further include a processor for wireless communication to generate a report that indicates information associated with data collected in accordance with a first configuration, wherein the information comprises at an identifier corresponding to the first configuration and a buffer size associated with an amount of data logged at a UE; and transmit the report.

Some implementations of the method and apparatuses described herein may further include a method performed by a UE, the method including generating a report that indicates information associated with data collected in accordance with a first configuration, wherein the information comprises an identifier corresponding to the first configuration and a buffer size associated with an amount of data logged at the UE; and transmitting the report.

Some implementations of the method and apparatuses described herein may further include an NE for wireless communication to transmit DCI indicating a request for at least a portion of the data associated with information; and receive a report that indicates information associated with the portion of the data collected by a UE in accordance with a first configuration, wherein the information comprises an identifier corresponding to the first configuration and a buffer size associated with an amount of data logged at the UE.

In some implementations of the method and apparatuses described herein, the NE transmits the DCI indicating a request for at least some of the data associated with the information in the report, wherein the request includes one or more identifiers corresponding to the at least some of the data; and receives the at least some of the data. In some implementations of the method and apparatuses described herein, the NE transmits a plurality of configurations including the first configuration, each configuration associated with an identifier, and wherein the information comprises a plurality of identifiers corresponding to each of the plurality of configurations and the buffer size associated with an amount of data logged at the UE for each of the plurality of configurations.

Additionally, or alternatively, the report is based at least in part on the amount of data collected and logged at the UE satisfying a threshold. Additionally, or alternatively, the NE receives an SR that requests one or more uplink resources for transmission of the report. Additionally, or alternatively, the NE receives, via an uplink control channel, a one-bit indication that the data is available for transmission by the UE. Additionally, or alternatively, report is transmitted via a logical channel, wherein the logical channel is mapped to more than one SR configuration. Additionally, or alternatively, the information included in the report is prioritized based at least in part on a priority of each configuration of a plurality of configurations.

Additionally, or alternatively, the information included in the report corresponds to at least one sample of the data based at least in part on a priority of the at least one sample for a given configuration. Additionally, or alternatively, the first configuration is associated with a plurality of configurations, and wherein the plurality of configurations comprises one or more measurement configurations, one or more measurement logging configurations, one or more reporting configurations, or a combination thereof. Additionally, or alternatively, the first configuration is associated with a plurality of configurations, and wherein each configuration of the plurality of configurations is associated with a UE-side condition or an NE-side condition.

Some implementations of the method and apparatuses described herein may further include a method performed by a NE, the method including transmitting DCI indicating a request for at least a portion of the data associated with information; and receiving a report that indicates information associated with the portion of the data collected by a UE in accordance with a first configuration, wherein the information comprises an identifier corresponding to the first configuration and a buffer size associated with an amount of data logged at the UE.

### BRIEF DESCRIPTION OF THE DRAWINGS

FIG. 1 illustrates an example of a wireless communications system in accordance with aspects of the present disclosure.

FIG. 2 illustrates an example AI framework, in accordance with aspects of the present disclosure.

FIG. 3 illustrates an example data collection status report (DCSR) medium access control (MAC) control element (MAC-CE), in accordance with aspects of the present disclosure.

FIG. 4 illustrates an example signaling diagram, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. The wireless communications systems can utilize AI and machine learning (ML) (AI/ML, which may be hereinafter referred to as “AI”) for various purposes, such as for network operation, network optimization, automated processing (e.g., self-driving cars in vehicle to everything (V2X) scenarios), network planning, security information and event management (SIEM)), etc. AI can leverage AI models (referred to herein as “models”) that represent programs and/or algorithms trained on a set of data to provide outputs, such as to recognize patterns, make decisions, generate content, etc. AI models, for instance, can apply different algorithms to data inputs to provide output for performing different operations (e.g., tasks, actions, processes, procedures).

AI in wireless communications systems can involve processes such as model training, model testing, and model inference to enable AI models to perform different operations pertaining to wireless communications. Multiple nodes (e.g., UEs and NEs) can be involved in AI functionality that can exchange data and can each perform different AI processing to perform AI operations. AI models can be trained for different datasets, scenarios, and configurations, and multiple models may be implemented (e.g., configured, constructed) for individual AI functionality supported by nodes. For instance, a model for an AI functionality supported by a particular node (e.g., a UE) may be trained with a dataset subject to conditions of a first node (e.g., UE and/or gNB) and conditions of a second node (e.g., a different UE and/or gNB).

Some schemes have been proposed to use AI models for wireless communications to reduce overhead, improve performance, and reduce latency. For example, AI/ML models can be used for channel state information (CSI) feedback compression, modulation/demodulation, scheduling, interference management, positioning, etc. Handling (e.g., design, optimization) of AI procedures and AI models can be use-case dependent. Further, training, updating, fine-tuning, and/or monitoring of models can be based on data collected from an environment.

Minimization of Drive Tests (MDT) is a feature introduced by the 3rd Generation Partnership Project (3GPP) for data measurement and collection from the environment. The purpose of this feature is to enhance the performance of networks and improve user experience by optimizing the data measurement and collection. Particularly, the goal is to minimize the reliance on drive tests, which are traditionally used to collect data for network optimization and troubleshooting. Drive tests involve sending personnel to physically drive around in vehicles equipped with measurement equipment to collect network performance data, which can be costly and time-consuming.

In an MDT framework, instead of a designated test equipment, a UE can be configured to measure various network performance data (e.g., indicators, parameters) such as signal strength, signal quality, and coverage. This data can then be used by network operators to assess and improve network performance. MDT is designed to collect data both in real-time and over extended periods, with measurement and collection being triggered in response to network events or periodically during normal UE usage. This passive and active data measurement and collection method enables network operators to obtain a comprehensive understanding of network conditions without deploying extensive field-testing resources. An MDT procedure can involve UEs being configured by the network to measure and collect data, which can include parameters like reference signal received power (RSRP), reference signal received quality (RSRQ), and other network performance data. The UE can report the data in response to one or more conditions being met or can log (e.g., store, buffer) the data for reporting at a later time (e.g., when reporting may have a reduced impact on UE performance and/or user experience). This measurement and collection method ensures continuous monitoring of network performance, allowing network operators to efficiently identify and resolve issues, optimize resource allocation, and enhance overall service quality. MDT leverages the widespread availability of UEs to provide a cost-effective and efficient way to maintain and improve mobile network performance.

A UE in a wireless communication system may operate in one or more modes, including a connected mode (also referred to as a radio resource control (RRC) connected mode or RRC connected state), an idle mode (also referred to as an RRC idle mode or RRC idle state), and an inactive mode (also referred to as an RRC inactive mode or RRC inactive state). An MDT framework may be designed (e.g., configured) separately for RRC-connected and RRC-idle/inactive UEs. For example, an MDT procedure for RRC-connected UEs may enable measurements being performed and reported instantaneously (e.g., in response to the performed measurements). Alternatively, an MDT procedure for RRC-idle/inactive UEs may allow for the measurements to be logged for a period of time based on a single configuration (e.g., a measurement configuration). As such, some MDT procedures are incompatible with AI/ML use cases.

For some life cycle management (LCM) phases for AI/ML use cases (e.g., training AI/ML models), a UE may have to collect data, for example by performing measurements. Because an NE (e.g., a gNB) may experience different conditions (also referred to as network-side conditions), it may be inefficient to limit the UE's data measurement, collection, logging, and reporting to a single configuration, which the NE may configure for the UE. If the NE configures the UE with multiple configurations, the UE may have different measured, collected, logged data for different configurations. The NE may be unaware of which data stored at the UE (e.g., buffer, memory) corresponds to which configuration. Similarly, the NE may be interested in specific data (e.g., for training or retraining an AI/ML model). Therefore, efficient mechanisms may be desired for reporting the measured, collected, logged data, which may be stored at the UE (e.g., in an access stratum (AS) buffer) corresponding to different configurations.

Aspects of the present disclosure are described in the context of a wireless communications system and include implementations that provide for efficient reporting of logged data and measurements, such as for AI/ML use cases (e.g., training data).

For instance, implementations described in the present disclosure include improvements to data reporting for AI models, e.g., improvements to MDT frameworks. For example, implementations provide for efficient data reporting of logged data related to AI/ML use cases (e.g., data for training AI models). Some aspects describe a UE providing information about data logged at the UE and available for reporting (e.g., transmission to a NE). This information may include an identifier corresponding to a configuration for which the data was logged, and a buffer size associated with an amount of the logged data (e.g., data size, data volume, data load). Based on the information, the NE may request the UE to report logged data (e.g., a subset of logged data) stored in the UE buffer. In some examples, the NE may request specific logged data from the UE (e.g., based on identifiers corresponding to configurations configured for the UE) and allocate resources (e.g., uplink shared channel (UL-SCH) resources) for the UE accordingly.

By utilizing the described techniques, consistent utilization of AI models and/or functionality across a wireless communication system (e.g., at UEs and/or NEs) can be realized, which can increase signaling accuracy, reduce signaling errors, and reduce signaling overhead, among other benefits.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

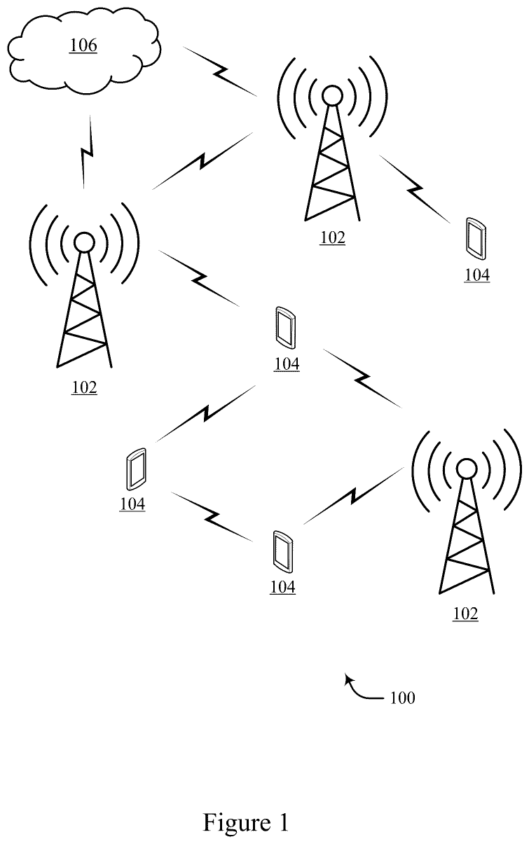

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz - 7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 may generate a report (e.g., a data collection status report (DCSR)) that indicates information associated with data collected by the UE 104 in accordance with a first configuration. The information may include an identifier corresponding to the first configuration and a buffer size associated with an amount of data logged at the UE 104. The UE 104 may transmit the report to an NE 102 (e.g., a base station, gNB). In some examples, the UE 104 may transmit the report based on a trigger. For example, the UE 104 may receive DCI from the NE 102, the DCI indicating a request for data associated with the information in the report. In some implementations, the requested data may be all of the data collected by the UE 104 or a subset of the data collected by the UE 104. Accordingly, the UE 104 may transmit the requested data. In some implementations, the NE 102 may transmit, to the UE 104, a set of multiple configurations including the first configuration. Each configuration may be associated with an identifier. In such implementations, the information in the report may include a set of multiple identifiers corresponding to each configuration and a buffer size associated with an amount of data logged at the UE 104 for each of the configurations.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

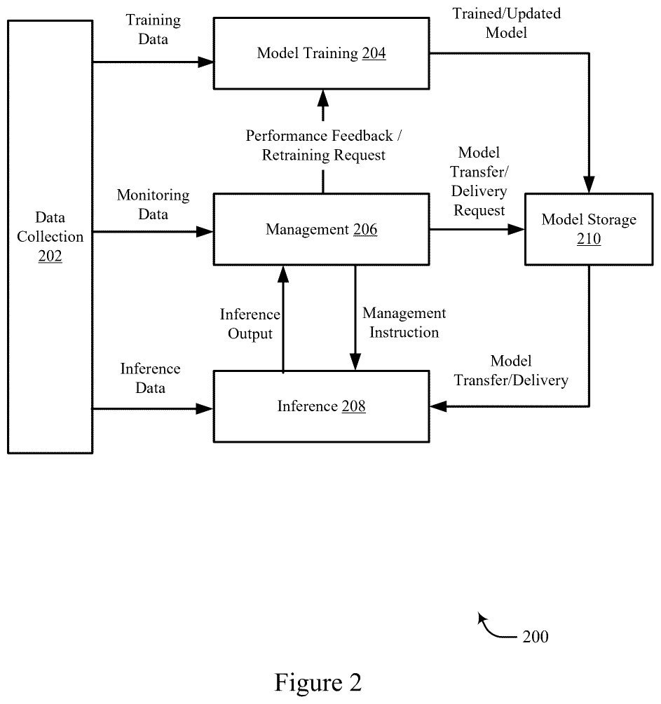

FIG. 2 illustrates an example AI framework 200. The AI framework 200 includes data collection functions 202, model training functions 204, management functions 206, inference functions 208, and model storage functions 210. The data collection function 202 can provide input data to the model training functions 204, management functions 206, and inference functions 208. The training data can represent data used as input for the model training function 204. The monitoring data can represent data used as input for the management functions 206 (e.g., for AI models and/or AI functionalities).

In the AI framework 200 inference data can be used as input for the inference functions 208. Further, the model training functions 204 can perform model training, validation, and testing which may generate model performance metrics that can be used as part of the model testing procedure. The model training functions 204 can also perform data preparation (e.g., data pre-processing and cleaning, formatting, and transformation) based on training data delivered by the data collection function 202. The management function 206 can oversee the operation (e.g., selection, (de)activation, switching, fallback, etc.) and monitoring (e.g., performance) of models and/or AI functionalities. The management function 206 can also make decisions to ensure the proper inference operation based on data received from the data collection function 202 and the inference function 208. Management instruction can represent information for input to manage the inference function 208, such as information for selection, (de)activation, switching of models and/or AI-based functionalities, fallback to non-AI/ML operation (e.g., not relying on inference processes), etc. A model transfer/delivery request can be used to request model(s) to the model storage function 210.

Further to the AI framework 200 performance feedback/retraining request can represent information for input for the model training function 204, e.g., for model (re)training and/or model updating purposes. The inference function 208 can provide outputs from processes of applying AI/ML models and/or AI/ML functionalities using the data that is provided by the data collection function 202 (e.g., inference data) as input. The inference function 208 can also perform data preparation (e.g., data pre-processing and cleaning, data formatting, data transformation, etc.) based on inference data delivered by the data collection function 202. Inference output can represent data used by the management function 206 to monitor the performance of models and/or AI/ML functionalities. The model storage functions 210 can store trained models and/or updated models that can be used to perform the inference functions 208.

NE and/or UE may support one or more types of MDT schemes, including immediate MDT and logged MDT. Immediate MDT involves real-time data collection from the UE configured by a network (e.g., the NE) or triggered in response to events or conditions and is applicable to the UE when the UE is in an RRC connected state. This enables (e.g., allows) the UE to report various measured and collected data (e.g., network performance data) to the network responsive to triggers, such as thresholds for signal strength or quality, being met. For example, the data reported may include network performance metrics such as RSRP, RSRQ, and other relevant metrics that provide a snapshot of the network's current state (e.g., current network performance). As immediate MDT may be able to provide real-time network data, it can be particularly useful in scenarios that demand quick resolution, such as during network outages or when optimizing handovers in dense urban environments. Immediate MDT thus enhances the capacity for proactive network management, contributing to improved user experience and more robust network operations.

Logged MDT is designed to enhance network performance monitoring by allowing a UE to collect and log network performance data over time. Unlike immediate MDT, which enables UEs to report the network performance data in real-time, logged MDT enables UEs to log (e.g., store, record) the network performance data (e.g., measured and collected network performance data) during normal usage (e.g., applicable when the UE is in an RRC inactive state and/or an RRC idle state) and then report the logged network performance data later (e.g., when the UE transitions to an RRC connected state), such as when the UE is idle or connected to a non-cellular network. This approach provides a comprehensive dataset without imposing significant overhead on the network or impacting user experience. The network can configure the UE for logged MDT by indicating one or more parameters to be measured and collected by the UE, one or more conditions under which measurement and collection should be performed, as well as the logging duration. The collected data may include network performance data such as signal strength (e.g., RSRP), signal quality (e.g., RSRQ), throughput, and location information, which can be based on global positioning system (GPS) or a cell identifier (e.g., cell-ID). The data may be stored in the UE's memory and updated (e.g., periodically) as the UE moves throughout a coverage area of the network and experiences varied network conditions. Once the logging duration is complete, or when conditions for data reporting are met, the UE may report (e.g., transmit) the logged data to the network. This reporting may occur when the UE has sufficient connectivity (e.g., when the UE is in an RRC connected state) without impacting service to the UE.

In each of these schemes, there are data collection and reporting operations (e.g., steps, tasks, actions). An MDT configuration message provisioned to the UE by the network contains detailed information on: one or more parameters to measure, timing and/or conditions for performing measurement on the one or more parameters, and reporting criteria. Put another way, the MDT configuration message may indicate specific parameters, such as signal strength, quality, and handover events. Additionally, the MDT configuration message may indicate the timing and conditions for measurement, for example, whether the UE performs the measurements periodically, event-triggered, or based on location. Additionally, the MDT configuration message may indicate a format, frequency (e.g., interval, periodicity), and destination for reporting the collected data to the network.

3GPP uses an information element (IE) MeasConfig, which is part of an RRCReconfiguration or RRCResume message, to configure MDT. The message may include: (i) IEs MeasIdToAddModList and measObjectToRemoveList, which contain a list of MeasObjectToAddMod (measurement identities) to add or modify where each measurement identities composed of an association between a measurement object and a reporting configuration. A measurement object configuration is identified by a measurement object identity and links one measurement object configuration with a measurement reporting configuration. By configuring multiple measurement identities, it is possible to link more than one measurement object to the same reporting configuration, as well as to link more than one reporting configuration to the same measurement object. The measurement object, MeasObject, primarily defines what to measure, e.g., a carrier frequency; (ii) IEs reportConfigToAddModList and reportConfigToRemoveList, which contain a list of measurement reporting configurations to add or modify and to remove. A measurement reporting configuration is identified by a measurement reporting configuration identity. Each measurement reporting configuration specifies, e.g., the reporting triggering criterion, reference signal type, reporting format, and reporting type.

The reporting type can be of event triggered reporting, periodic reporting, cell global identity (CGI) reporting, or space-frequency time diversity (SFTD) reporting. Also, for logged MDT, the UE can be configured to start logging using a LoggedMeasurementConfiguration message. A summary of parameters/methods defined in MDT for the reporting/logging is as follows:

Threshold-Based: The network configures thresholds for different channel state information (CSI) reference signal (CSI-RS)-based metrics using which the UE decide when to report/log the data. (i) RSRP: The power of the CSI-RS received by the UE; (ii) RSRQ: The quality of the CSI-RS received by the UE, taking into account both signal strength and interference; (iii) (Signal-to-Interference-plus-Noise Ratio) SINR: The ratio of the desired signal power to the interfering and noise power in the CSI-RS.

Time-Based Reporting Criteria: (i) Logging Interval: Specifies the interval at which the UE logs the measurement data, such as in ms or seconds (e.g., every 120 ms); (ii) Duration: Total duration for which the reporting is active (e.g., over a period of 10 minutes).

Location-Based Reporting Criteria: (i) Area-based Reporting: Data collection can be triggered when the UE enters or exits specific cell identifiers or area defined by an IE areaConfiguration; (ii) Spatial Relation Based Reporting (e.g., SFTD): Leverages the concept of “spatial relations” between the UE and reference points, which can be beams (defined by beam reference signals) or cell identities. Reports can be triggered based on trigger events such as: Entering or leaving a specific beam (SFTD-enter, SFTD-leave); distance to a beam satisfying (e.g., exceeding) a certain threshold (SFTD-distance); Distance to a cell satisfying (e.g., exceeding) a certain threshold, signal quality falling below a signal quality threshold, etc.

Event Triggered Measurements and Reporting: These events are predefined conditions such as changes in signal strength or quality that trigger data collection. The UE starts gathering data when these events occur: Event A1: Serving cell becomes better than a threshold; Event A2:

Serving cell becomes worse than a threshold; Event A3: Neighbour becomes amount of offset better than a primary cell (PCell)/primary secondary cell (PSCell); Event A4: A neighbour cell becomes better than a threshold; Event A5: PCell/PSCell becomes worse than absolute threshold1 AND Neighbour/SCell becomes better than another absolute threshold2; Event A6: Neighbour becomes amount of offset better than a secondary cell (SCell); Event B1: Inter-radio access technology (RAT) neighbour cell becomes better than a threshold; Event B2: PCell becomes worse than absolute threshold1 AND Neighbour becomes better than another absolute threshold2.

For an event-based reporting, IE triggerConfig defines the conditions that trigger a measurement report which contains:
triggerType: Specifies the type of trigger as an event: Report when a specific event occurs (e.g., crossing signal strength threshold, entering a new cell); periodic: Report at regular intervals; onDemand: Report upon explicit request from the network.
eventId (for event triggers): The specific event identifier (ID).
triggerQuantity (for event triggers): The measurement quantity to be monitored for the event (e.g., RSRP, RSRQ, SINR).
Thresholds and offsets: The threshold values and offset used for triggering the report.
Hysteresis: A margin to prevent frequent triggering near the threshold.
timeToTrigger (for event triggers): The time duration to wait after the event condition is met before triggering the report.
reportInterval (for periodic triggers): The time interval between reports.
reportAmount (for periodic triggers): The number of reports to send after a trigger.
reportOnLeave: whether or not the UE is to initiate the reporting procedure when the leaving condition.

The measurement and reporting mechanism for MDT are mainly developed for the MDT use cases. To reuse the MDT framework for data collection for AI model training, monitoring, or model update, the framework may need to be optimized as discussed in the present disclosure.

For AI/ML use cases, a logged measurement report used for logged MDT may include IEs logMeasInfoList and logMeasAvailable. In logged MDT, logged measurement results are included in the IE logMeasInfoList. If the UE cannot transmit an RRC message for all the logged measurements stored by the UE, the UE signals to the network via the IE logMeasAvailable (e.g., a flag) indicating that there are logged data still available for transmission to an NE (e.g., a gNB). No standardized RRC segmentation is specified for this case. Instead, it is the UE implementation that is based on the current size of an uplink RRC message, which determines how large the information should be that is included in logMeasInfoList. This is possible because the size of entries in the logMeasInfoList (i.e., LogMeasInfo) are very much below the maximum supported size.

In the logged MDT, the logged measurements stored by the UE are signaled in a list of logged measurement results (i.e., logMeasInfoList). The UE implementation can determine how many entries to include in this list such that the maximum packet data convergence protocol (PDCP) service data unit (SDU) size is not exceeded. No standardized RRC segmentation procedure is used in the logged MDT.

The logged MDT use case is very similar to an AI/ML use case. No standardized RRC segmentation procedure needs to be specified for the reporting of collected data for network-side model training. The collected data can be introduced in a measurement results list, where each entry corresponds to measurements performed at different points in time. If the overall amount of collected data exceeds the maximum PDCP SDU size, it is the UE implementation that makes sure to populate such measurement result lists accordingly. This would reduce standardization efforts needed to define an RRC segmentation procedure.

The 3GPP supports several agreements on data logging for a network-side model. As a baseline approach, the UE receives a measurement configuration for AI/ML-enabled features or feature groups for data collection and logging of measurements. The network can explicitly configure the UE regarding whether the corresponding data collection and logging (if supported) should be immediately started. Multiple configurations may be provided to the UE, and dynamic activation/deactivation may be supported. In addition, the UE stores logged training data at an access stratum (AS) layer with a minimum AS layer memory size supported by the UE (where the memory size may vary). Additionally, when the UE reaches its buffer limitation, the UE may stop measurement for data collection purposes and logging. In addition, measurements for data collection purposes and logging can be controlled based on a power state of the UE. It is up to UE implementation how the UE determines the power state. In some cases, the UE may stop autonomously or may report to the network. In some examples, AS buffer event-based reporting may be supported, where the UE may send an availability indication or a full report if supported. In addition, event-based data collection and logging may be supported, as well as on-demand request for reports from the network. Additionally, UE implementation can determine how many entries to include in list radio measurements information, such that a maximum PDCP SDU size is not exceeded. No standardized RRC segmentation procedure is needed (as for the logged MDT measurements, and the UE may refrain from transmitting a data collection report over a signaling radio bearer (SRB) (e.g., SRB1).

Aspects of the present disclosure include solutions for optimization of data collection and reporting for different AI use cases.

In some implementations, a UE may transmit control signaling to an NE, the control signaling providing information about logged data and measurements at the UE for the purposes of LCM. The UE may transmit the control signaling to report logged data which is to be used to train an AI/ML model. In some examples, the control signaling may include a medium access control (MAC) control element (MAC-CE), which may be referred to herein as a DCSR MAC-CE or a DCSR. The UE may use the DCSR to provide a serving NE (e.g., gNB) with information about data that is logged at the UE and available for AI-related scenarios.

The UE may generate the DCSR MAC-CE that indicates information associated with data collected in accordance with a first configuration (of a set of multiple configurations) and logged at the UE. The first configuration may be a measurement configuration, a measurement logging configuration, or a reporting configuration. The DCSR may include information about the amount of data (e.g., in bytes) logged at the UE for each configuration (or data collection) for which the UE has some logged data stored in a buffer. For example, the information may include an identifier (e.g., dataCollectID) corresponding to the first configuration and a buffer size associated with an amount of data logged at the UE.

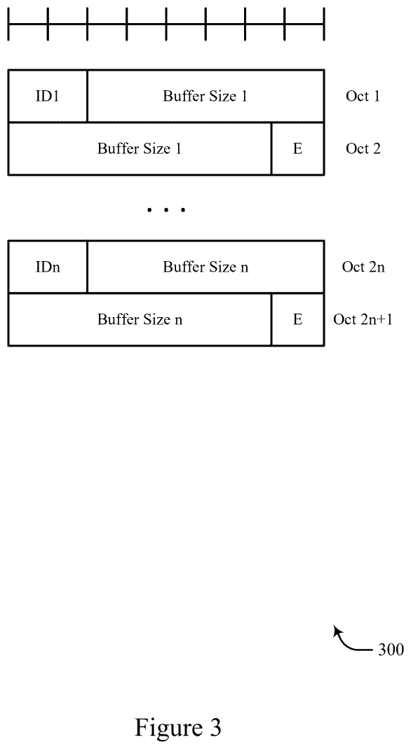

In some implementations, the UE may be configured with multiple configurations. The NE may transmit a set of multiple configurations including the first configuration to the UE. The set of multiple configurations may include one or more measurement configurations, one or more measurement logging configurations, one or more reporting configurations, or any combination thereof. The UE may collect data or perform particular measurements at a given time based on the configurations it currently has, which may save processing power (e.g., as the UE does not collect data for every configuration at all times). In some implementations, each configuration may be associated with a UE-side condition or an NE-side condition. In addition, each configuration may be associated with an identifier (e.g., a unique identifier, dataCollectID). Accordingly, the DCSR may include multiple identifiers (e.g., indicated via an ID field) that unambiguously identify different logged data associated with a respective configuration. The identifiers (e.g., dataCollectID) may be based on, or may be the same as, the measId used in a measurementConfig message. The DCSR may also include a buffer size field indicating a total amount of logged data for each of the configurations available in the UE. Additional details regarding the DSCR MAC-CE are described herein with reference to FIG. 3.

According to some implementations, the UE may transmit the DSCR (e.g., a DSCR MAC-CE) based on a predefined condition. For example, the UE may be triggered to transmit the DSCR if an amount of data logged at the UE for a particular configuration, or for the set of multiple configurations configured for the UE, exceeds a threshold. Alternatively, the UE may be triggered to transmit the DCSR according to a configured periodicity. For example, a MAC entity of the UE may be configured with a timer (e.g., period_DCSR timer), which may be started upon the transmission of the DCSR. The MAC entity may trigger the transmission of another DCSR when the timer expires.

In some implementations, a request from the NE may trigger the UE to transmit the DCSR. The NE may transmit downlink control signaling (e.g., DCI) requesting the UE to report information about the logged data for AI/ML purposes. For example, the NE may transmit DCI indicating a request for at least some of the data associated with the information in the report, and the UE may accordingly transmit the requested data to the NE. According to one implementation, a field in the DCI may indicate a request for the transmission of the logged data. The field may indicate a “logged data” request. Alternatively, an existing field within a DCI may be repurposed to indicate the request. A combination of existing fields within the DCI set to particular values or codepoints may indicate the request for transmission of the logged data.

In some implementations, the DCI may include one or more identifiers corresponding to the identifiers (e.g., dataCollectIDs) for which the UE is requested to send the logged data. Based on the information provided in a received DCSR, for example, the NE may request only specific logged data, which may be used for training an AI/ML model. The DCI may include a field for signaling the identifiers (e.g., dataCollectIDs). In one implementation, the NE may use a reserved (predefined) codepoint to request all of the logged data that is related to the AI/ML model. In some implementations, the NE may request some or all of the logged data from the UE based on a DCSR (previously provided from the UE). In another example, a received DCSR may trigger the NE to allocate uplink resources to the UE for transmission of the logged data. In some examples, the DCI may allocate uplink resources (e.g., physical uplink shared channel (PUSCH)) resources to indicate the request for the logged data. In response to receiving this DCI, the UE may generate a MAC PDU including the requested data and transmit the MAC PDU on the allocated uplink resources. In some examples, the NE may transmit the request for the transmission of logged data via an RRC message. In some implementations, the RRC messaged e.g., a “logged data request” message, may include one or more identifiers corresponding to the identifiers (e.g., dataCollectIDs) for which the UE is requested to send the logged data.

In some alternative implementations, the UE may transmit the DCSR via an RRC message. For example, the UE may transmit the DCSR within a UE assistance information (UAI) message, where the UAI may be used to provide detailed information about the logged data related to AI/ML models. In some examples, the UE may generate one or more RRC messages containing AI/ML-related data or measurements upon predefined trigger conditions. For cases when the UE has logged data stored in a buffer (e.g., AI/ML training data stored at some buffer in the AS layer), the UE may behave based on different triggers. According to one implementation, the UE may generate, upon reception of a request to transmit logged data (e.g., a DCI or RRC message as described herein), one or more RRC messages including the requested logged data. When the UE submits the generated RRC messages to the PDCP layer, a buffer status report (BSR) or an SR may be triggered.

In some examples, the UE may generate one or more RRC messages for transmitting the logged data based on determining that the amount of logged data stored in the buffer of the UE has exceeded a predefined percentage of the total buffer size. For cases when periodic reporting of logged data is configured, the UE may generate the one or more RRC messages with a configured periodicity and transmit them to the PDCP layer accordingly. In another implementation, the UE may trigger transmission of the DCSR upon having generated the one or more RRC messages indicating the logged data.

In some examples, the UE may discard the logged data stored in the AS buffer upon transmission/reporting of this data to the NE. In some implementations, the UE may discard logged data upon reception of an acknowledgement from the NE that the NE successfully received the logged data. In order to maintain the AS buffer for logged data, (e.g., to allow for the collection of new measurements/data samples), the UE may discard the data which it has already reported to the NE. In one example, the UE may receive an acknowledgment for a successful transmission of logged data to the NE via a DCI with a toggled new data indicator (NDI) (e.g., uplink DCI allocation resources for an initial transmission for a hybrid automatic repeat request (HARQ) process on which the logged data, such as a PUSCH transmission, was transmitted).

In some implementations, the UE may cancel transmission of a triggered DCSR when there is no data logged at the UE for AI/ML use cases (e.g., when the DCSR contains empty buffer sizes). In some other implementations, the UE may skip some entries (e.g., logged data indications) for particular identifiers (e.g., dataCollectIDs) from the DCSR if all of the logged data for those identifiers has already been scheduled to be reported. Alternatively, the UE may cancel transmission of the triggered DCSR, for example, in cases where all of the logged data has already been scheduled to be reported.

In some implementations, the UE may transmit an indication to the network via a physical uplink control channel (PUCCH) about the information associated with the data. The UE may transmit a one-bit indication via the PUCCH to indicate that the UE has some logged data (relevant for training the AI/ML model) available for transmission. In one example, the UE may use an SR to indicate the availability of the logged data, where the SR may be reserved for this purpose. The SR, when being transmitted via the PUCCH, may indicate that the buffer used for logging the data is at least filled with logged data up to a pre-defined level (e.g., 90% of the buffer is occupied).

In some other implementations, the UE may use a radio bearer associated with a logical channel to transmit the logged data, where the radio bearer may be mapped to multiple SR configurations. An SR may be used for requesting UL-SCH resources for a new transmission, and a MAC entity of the UE may be configured with zero, one, or multiple SR configurations. An SR configuration may include a set of PUCCH resources for SRs across different bandwidth parts (BWPs) and cells. Each SR configuration may correspond to one or more logical channels and/or some MAC-CEs (e.g., SCell beam recovery, consistent listen-before-talk (LBT) failure recovery, or both).

Each logical channel, or a specific MAC-CE, may be mapped to zero or one SR configuration, which may be configured via RRC signaling. In such cases, a logical channel serving a radio bearer, which may be used for the transmission of the logged data, may be mapped to more than one SR configuration. In one example, the UE may use a specific SR configuration when a BSR or SR was triggered due to the transmission of the logged data. Alternatively, the UE may trigger or use a different SR configuration (e.g., a legacy SR configuration) when the BSR or SR was triggered due to the transmission of other messages or data. In one specific implementation, the UE may use an SRB to transmit the logged data. For cases when the UE triggers or uses an SR to request UL-SCH resources for the transmission of the logged data, the UE may use one reserved SR configuration and the remaining SR configurations to transmit other RRC messages. That is, the UE may use a different SR configuration to request uplink resources depending on the type of RRC message it is to transmit.

Using multiple different SR configurations for an SRB or logical channel may enable an NE to distinguish among different requests from the UE. In this way, behavior of the NE may be tailored according to the type of RRC message it receives. For example, since data used for training AI/MI models may be associated with less strict latency requirements compared to other types of RRC messages, the NE may not need to assign uplink resources for transmission of the data immediately. Additionally, as the amount of data logged at the UE for training the AI/ML models may be relatively large (compared to other types of RRC messages), the NE may assign more uplink resources in response to receiving an SR indicating the availability of such logged data. Alternatively, the NE may request transmission of a DCSR (e.g., via a MAC-CE) in order to obtain more information about the data logged at the UE (e.g., data size).

In some examples, different configurations may be associated with different priorities. In addition, each configuration may be identified by a unique identifier (e.g., dataCollectID). The UE and the NE may use the priorities associated with each configuration to prioritize data logged at the UE. For example, the UE may prioritize a portion of the data (e.g., one AI/ML measurement) over other data based on the priorities of corresponding configurations when the UE is capable of performing a limited amount of data collection (e.g., a limited quantity of AI/ML-related measurements), or when the UE is power limited. In some examples, the UE may use the priorities associated with the configurations to report logged data to the NE (e.g., to generate the RRC message or the MAC-CE).

If the quantity of UL-SCH resources available to the UE are insufficient to transmit all of the requested logged data available for transmission, the UE may use the priority of a corresponding configuration to determine which of the logged data to multiplex first on the available UL-SCH resources. In one example, the UE may determine a priority order for multiplexing the logged data (e.g., a priority order for generating the RRC message or the MAC-CE). In one example, the message containing logged data may further indicate that there is additional data logged at the UE and available for transmission. As such, this indication may indicate to the NE that the RRC message or the MAC-CE does not include all of the available logged data.

Additionally, the UE may assign a sample-priority to different samples corresponding to each configuration. That is, different data samples corresponding to different configurations may be associated with different priorities. For examples, the UE may prioritize different samples based on statistics such as how important the data is to training an AI/ML model (e.g., what types of measurements will train the model most effectively). The UE may use the sample-priorities to prioritize data it may report to the NE when the UE is capable of performing a limited amount of data collection (e.g., performing a limited number of AI/ML related measurements for the purpose of data collection). In one example, the UE may prioritize reporting of data samples with higher sample-priorities when the UE is power-limited or resource-limited. The UE may use the combination of the sample-priorities and the configuration priorities described herein to determine which data to transmit if the UE is capable of transmitting a limited amount of data.

In some examples, the UE may map configurations (e.g., identified by an identifier such as dataCollectID) to logical channels or radio bearers configured for the UE. For example, the UE may map different logged data to different logical channels. In some examples, the UE may map some higher-priority data (e.g., determined based on a priority of a corresponding configuration) to a logical channel that is configured with a higher logical channel priority. In some exampes, the identifiers associated with each configuration (e.g., dataCollectID) may be based on the measId used in a measurementConfig message. Mapping data to different logical channels in this way may enable differentiated treatment of corresponding uplink reporting.

FIG. 3 illustrates an example DCSR MAC-CE 300. The DCSR MAC-CE 300 may be an example of a DCSR MAC-CE described herein with reference to FIG. 2. For example, a UE may transmit the DCSR MAC-CE 300 to an NE, where the DCSR MAC-CE 300 may indicate information associated with data collected and logged at the UE in accordance with a first configuration.

The DCSR MAC-CE 300 may be identified by a MAC subheader with a logical channel identifier (LCID) or an extended LCID (eLCID). The information may include an identifier field (e.g., ID1, ID n) and a buffer size field (e.g., buffer size 1, buffer size n). The identifier field may include an identifier corresponding to the first configuration, and the buffer size field may include a buffer size associated with an amount of data logged at the UE. Additionally, the DCSR MAC-CE 300 may include an extension flag (e.g., an E field), which may indicate whether another identifier field and another buffer size field are following in the DCSR MAC-CE 300.

In alternate implementations, the DCSR MAC-CE 300 may report information regarding whether the UE has logged data that is relevant to an AI/ML model. In such cases, the DCSR MAC-CE 300 may include a single-bit indicator to represent the presence (i.e., availability) of relevant logged data at the UE. In one example, the UE may report a total amount of logged data relevant to an AI/ML model in the DCSR MAC-CE 300. In some implementations, the DCSR MAC-CE 300 may be linked with an SR configuration. If the UE has been triggered to transmit a DCSR MAC-CE 300 but lacks any available UL-SCH resources to do so, the UE may trigger transmission of an SR to request uplink resources for the transmission of the DCSR MAC-CE 300. The disclosed techniques may support other implementations of the DCSR MAC-CE 300.

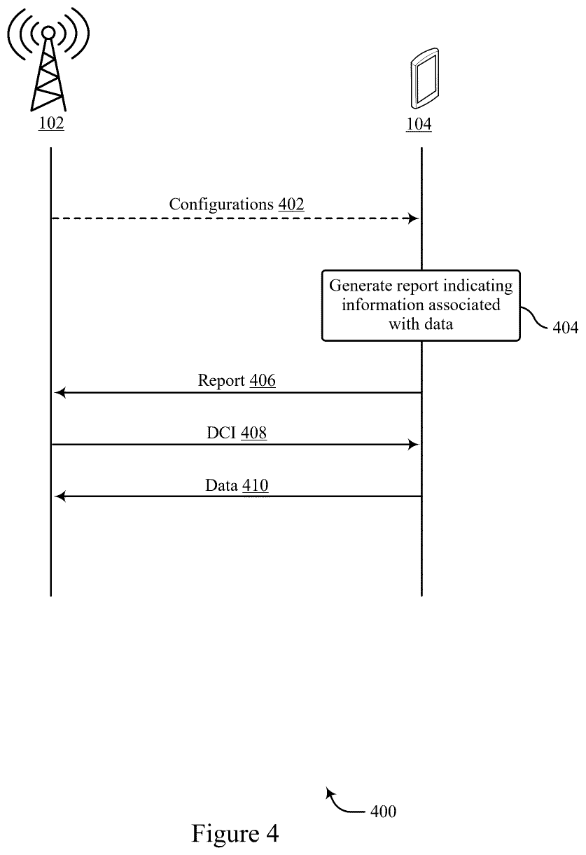

FIG. 4 illustrates an example signaling diagram 400 in accordance with aspects of the present disclosure. In some examples, the signaling diagram 400 may implement aspects of the wireless communications system 100, the AI framework 200, and the DCSR MAC-CE 300. For example, the signaling diagram 400 may be implemented by a UE 104 and a NE 102, which may be examples of a UE 104, and a NE 102 as described with reference to FIG. 1. For example, the UE 104 may transmit a report to the NE 102 indicating information associated with data the UE collected in accordance with a configuration, and the NE 102 may transmit control signaling requesting specific data associated with the information in the report. Alternative examples of the following may be implemented, where some processes are performed in a different order than described or are not performed. In some cases, processes may include additional features not mentioned below, or further processes may be added.

At 402, the NE 102 may transmit, to the UE 104, a set of multiple configurations including a first configuration. Each configuration may be associated with an identifier (e.g., dataCollectID). The set of multiple configurations may include one or more measurement configurations, one or more measurement logging configurations, one or more reporting configurations, or a combination thereof.

The UE 104 may receive, from the NE 102, the set of multiple configurations including the first configuration. At 404, the UE 104 may generate a report that indicates information associated with data collected in accordance with the first configuration, where the information includes an identifier corresponding to the first configuration (e.g., a dataCollectID) and a buffer size associated with an amount of data logged at the UE 104. In some examples when the NE 102 configures the UE 104 with multiple configurations, the information may include multiple identifiers corresponding to each of the configurations for which data is being reported, and the buffer size may be associated with an amount of data logged at the UE for each of the configurations.

In some examples, the UE 104 may generate the report based on an amount of data collected and logged at the UE 104 (e.g., in a buffer) satisfying (e.g., exceeding) a threshold. Additionally, or alternatively, the UE 104 may generate the report in accordance with priorities of each configuration. That is, the UE 104 may prioritize the data that it includes in the report based on priorities of data samples (e.g., network performance metrics, statistics relevant to training an AI/ML model), which may depend on priorities of corresponding configurations.

At 406, the UE 104 may transmit the report to the NE 102. In some examples, the report may be a DCSR, and the UE 104 may transmit the DCSR via a MAC-CE. In some examples, the UE 104 may transmit an SR that requests one or more resources (e.g., UL-SCH resources) for transmission of the report. Additionally, the UE 104 may transmit a one-bit indication (e.g., via uplink control information (UCI) or other control signaling) to the NE 104 (e.g., via a PUCCH) to indicate that data logged at the UE 104 is available for transmission.

At 408, the NE 102 may transmit, to the UE 104, a DCI indicating a request for at least some (e.g., subset, portion) of the data associated with the information in the report. The request may include one or more IDs corresponding to at least some of the data. That is, the request may indicate to the UE 104 which data (corresponding to which configurations) it is to transmit to the NE 102. At 410, the UE 104 may transmit the requested data to the NE 102.

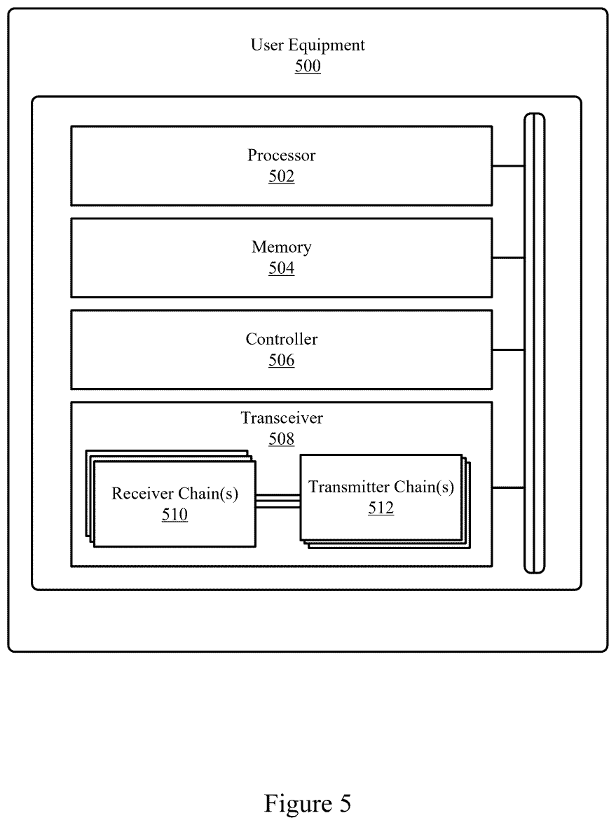

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for generating a report that indicates information associated with data collected in accordance with a first configuration, wherein the information comprises an identifier corresponding to the first configuration and a buffer size associated with an amount of data logged at the UE 500; and transmitting the report.

Additionally, the UE 500 may be configured to support any one or combination of receiving DCI indicating a request for at least some of the data associated with the information in the report, wherein the request includes one or more identifiers corresponding to the at least some of the data; and transmitting the at least some of the data. Additionally, or alternatively, the UE 500 may be configured to support receiving a plurality of configurations including the first configuration, each configuration associated with an identifier, and wherein the information comprises a plurality of identifiers corresponding to each of the plurality of configurations and the buffer size associated with an amount of data logged at the UE 500 for each of the plurality of configurations.

Additionally, or alternatively, the report may be generated based at least in part on the amount of data collected and logged at the UE 500 satisfying a threshold. Additionally, or alternatively, the UE 500 may be configured to support transmitting an SR that requests one or more uplink resources for transmission of the report. Additionally, or alternatively, the UE 500 may be configured to support transmitting, via an uplink control channel, a one-bit indication that the data is available for transmission. Additionally, or alternatively, the report is transmitted via a logical channel, wherein the logical channel may be mapped to more than one SR configuration.

Additionally, or alternatively, the UE 500 may be configured to prioritize the information included in the report based at least in part on a priority of each configuration of a plurality of configurations. Additionally, or alternatively, the information included in the report corresponds to at least one sample of the data based at least in part on a priority of the at least one sample for a given configuration. Additionally, or alternatively, the first configuration may be associated with a plurality of configurations, and wherein the plurality of configurations comprises one or more measurement configurations, one or more measurement logging configurations, one or more reporting configurations, or a combination thereof. Additionally, or alternatively, the first configuration is associated with a plurality of configurations, and each configuration of the plurality of configurations is associated with a UE-side condition or an NE-side condition.

Additionally, or alternatively, the UE 500 may support at least one memory (e.g., the memory 504) and at least one processor (e.g., the processor 502) coupled with the at least one memory and configured to cause the UE 500 to generate a report that indicates information associated with data collected in accordance with a first configuration, wherein the information comprises an identifier corresponding to the first configuration and a buffer size associated with an amount of data logged at the UE 500; and transmit the report.

Additionally, the at least one processor is configured to support any one or combination of receiving DCI indicating a request for at least some of the data associated with the information in the report, wherein the request includes one or more identifiers corresponding to the at least some of the data; and transmitting the at least some of the data. Additionally, or alternatively, the at least one processor is configured to support receiving a plurality of configurations including the first configuration, each configuration associated with an identifier, and wherein the information comprises a plurality of identifiers corresponding to each of the plurality of configurations and the buffer size associated with an amount of data logged at the UE 500 for each of the plurality of configurations.

Additionally, or alternatively, the report may be generated based at least in part on the amount of data collected and logged at the UE 500 satisfying a threshold. Additionally, or alternatively, the at least one processor is configured to support transmitting an SR that requests one or more uplink resources for transmission of the report. Additionally, or alternatively, the U the at least one processor is configured to support transmitting, via an uplink control channel, a one-bit indication that the data is available for transmission. Additionally, or alternatively, the report is transmitted via a logical channel, wherein the logical channel may be mapped to more than one SR configuration.

Additionally, or alternatively, the at least one processor is configured to prioritize the information included in the report based at least in part on a priority of each configuration of a plurality of configurations. Additionally, or alternatively, the information included in the report corresponds to at least one sample of the data based at least in part on a priority of the at least one sample for a given configuration. Additionally, or alternatively, the first configuration may be associated with a plurality of configurations, and wherein the plurality of configurations comprises one or more measurement configurations, one or more measurement logging configurations, one or more reporting configurations, or a combination thereof. Additionally, or alternatively, the first configuration is associated with a plurality of configurations, and each configuration of the plurality of configurations is associated with a UE-side condition or an NE-side condition.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

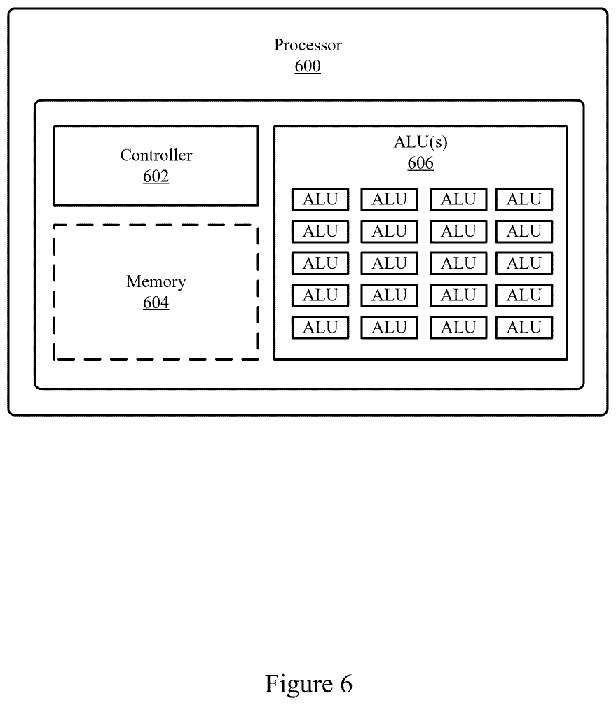

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to generate a report that indicates information associated with data collected in accordance with a first configuration, wherein the information comprises an identifier corresponding to the first configuration and a buffer size associated with an amount of data logged at the memory 604 (e.g., of a UE); and transmit the report.

Additionally, the processor 600 may be configured to or operable to support any one or combination of receiving DCI indicating a request for at least some of the data associated with the information in the report, wherein the request includes one or more identifiers corresponding to the at least some of the data; and transmitting the at least some of the data. Additionally, or alternatively, the processor 600 may be configured to or operable to support receiving a plurality of configurations including the first configuration, each configuration associated with an identifier, and wherein the information comprises a plurality of identifiers corresponding to each of the plurality of configurations and the buffer size associated with an amount of data logged at the memory 604 (e.g., of the UE) for each of the plurality of configurations.

Additionally, or alternatively, the report may be generated based at least in part on the amount of data collected and logged at the memory 604 (e.g., of the UE) satisfying a threshold. Additionally, or alternatively, the processor 600 may be configured to or operable to support transmitting an SR that requests one or more uplink resources for transmission of the report. Additionally, or alternatively, the processor 600 may be configured to or operable to support transmitting, via an uplink control channel, a one-bit indication that the data is available for transmission. Additionally, or alternatively, the report is transmitted via a logical channel, wherein the logical channel may be mapped to more than one SR configuration.

Additionally, or alternatively, the processor 600 may be configured to or operable to support prioritizing the information included in the report based at least in part on a priority of each configuration of a plurality of configurations. Additionally, or alternatively, the information included in the report corresponds to at least one sample of the data based at least in part on a priority of the at least one sample for a given configuration. Additionally, or alternatively, the first configuration may be associated with a plurality of configurations, and wherein the plurality of configurations comprises one or more measurement configurations, one or more measurement logging configurations, one or more reporting configurations, or a combination thereof. Additionally, or alternatively, the first configuration is associated with a plurality of configurations, and each configuration of the plurality of configurations is associated with a UE-side condition or an NE-side condition.

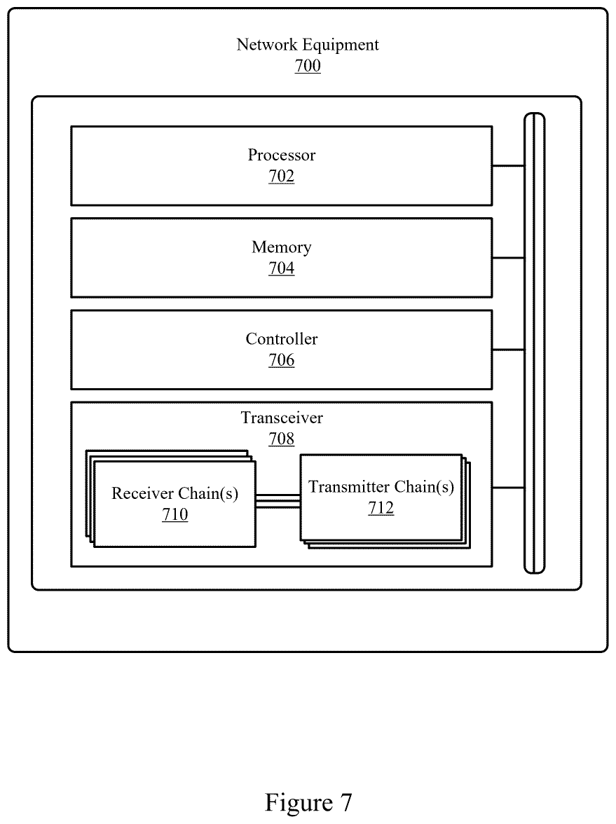

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for transmitting DCI indicating a request for at least a portion of the data associated with information; and receiving a report that indicates information associated with the portion of the data collected by a UE in accordance with a first configuration, wherein the information comprises an identifier corresponding to the first configuration and a buffer size associated with an amount of data logged at the UE.

Additionally, the NE 700 may be configured to or operable to support any one or combination of the transmitting DCI indicating a request for at least some of the data associated with the information in the report, wherein the request includes one or more identifiers corresponding to the at least some of the data; and receiving the at least some of the data. Additionally, or alternatively, the NE 700 may be configured to support transmitting a plurality of configurations including the first configuration, each configuration associated with an identifier, and wherein the information comprises a plurality of identifiers corresponding to each of the plurality of configurations and the buffer size associated with an amount of data logged at the UE for each of the plurality of configurations.

Additionally, or alternatively, the report may be based at least in part on the amount of data collected and logged at the UE satisfying a threshold. Additionally, or alternatively, the NE 700 may be configured to support receiving an SR that requests one or more uplink resources for transmission of the report by the UE. Additionally, or alternatively, the NE 700 may be configured to support receiving, via an uplink control channel, a one-bit indication that the data is available for transmission by the UE. Additionally, or alternatively, the report is received via a logical channel, wherein the logical channel may be mapped to more than one SR configuration.

Additionally, or alternatively, the information included in the report may be prioritized based at least in part on a priority of each configuration of a plurality of configurations. Additionally, or alternatively, the information included in the report corresponds to at least one sample of the data based at least in part on a priority of the at least one sample for a given configuration. Additionally, or alternatively, the first configuration may be associated with a plurality of configurations, and wherein the plurality of configurations comprises one or more measurement configurations, one or more measurement logging configurations, one or more reporting configurations, or a combination thereof. Additionally, or alternatively, the first configuration is associated with a plurality of configurations, and each configuration of the plurality of configurations is associated with a UE-side condition or an NE-side condition.

Additionally, or alternatively, the NE 700 may support at least one memory (e.g., the memory 704) and at least one processor (e.g., the processor 702) coupled with the at least one memory and configured to cause the NE to transmit DCI indicating a request for at least a portion of the data associated with information; and receiving a report that indicates information associated with the portion of the data collected by a UE in accordance with a first configuration, wherein the information comprises an identifier corresponding to the first configuration and a buffer size associated with an amount of data logged at the UE.

Additionally, the at least one processor may be configured to support any one or combination of transmitting DCI indicating a request for at least some of the data associated with the information in the report, wherein the request includes one or more identifiers corresponding to the at least some of the data; and receiving the at least some of the data. Additionally, or alternatively, the at least one processor may be configured to support transmitting a plurality of configurations including the first configuration, each configuration associated with an identifier, and wherein the information comprises a plurality of identifiers corresponding to each of the plurality of configurations and the buffer size associated with an amount of data logged at the UE for each of the plurality of configurations.

Additionally, or alternatively, the report may be based at least in part on the amount of data collected and logged at the UE satisfying a threshold. Additionally, or alternatively, the at least one processor may be configured to support receiving an SR that requests one or more uplink resources for transmission of the report by the UE. Additionally, or alternatively, the at least one processor may be configured to support receiving, via an uplink control channel, a one-bit indication that the data is available for transmission by the UE. Additionally, or alternatively, the report is received via a logical channel, wherein the logical channel may be mapped to more than one SR configuration.

Additionally, or alternatively, the information included in the report may be prioritized based at least in part on a priority of each configuration of a plurality of configurations. Additionally, or alternatively, the information included in the report corresponds to at least one sample of the data based at least in part on a priority of the at least one sample for a given configuration. Additionally, or alternatively, the first configuration may be associated with a plurality of configurations, and wherein the plurality of configurations comprises one or more measurement configurations, one or more measurement logging configurations, one or more reporting configurations, or a combination thereof. Additionally, or alternatively, the first configuration is associated with a plurality of configurations, and each configuration of the plurality of configurations is associated with a UE-side condition or an NE-side condition.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

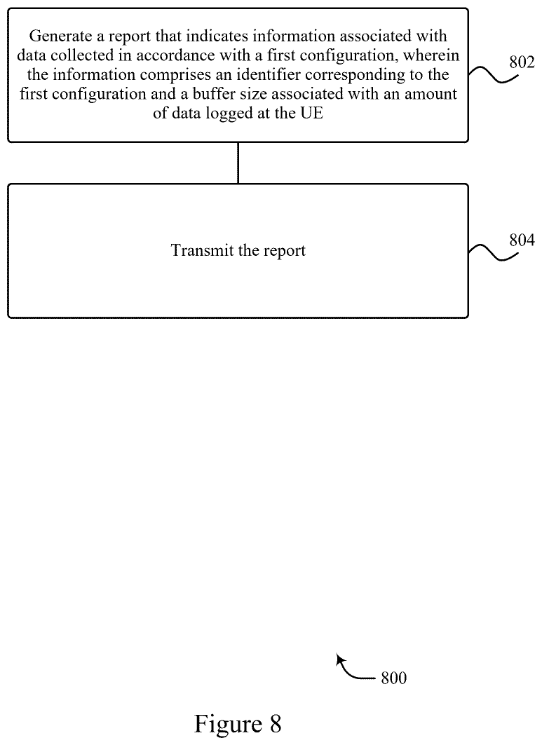

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include generating a report that indicates information associated with data collected in accordance with a first configuration, wherein the information comprises an identifier corresponding to the first configuration and a buffer size associated with an amount of data logged at the UE. The operations of 802 may be performed in accordance with examples as described herein. In some implementations, aspects of the operations of 802 may be performed by a UE as described with reference to FIG. 5.

At 804, the method may include transmitting the report. The operations of 804 may be performed in accordance with examples as described herein. In some implementations, aspects of the operations of 804 may be performed by a UE as described with reference to FIG. 5.

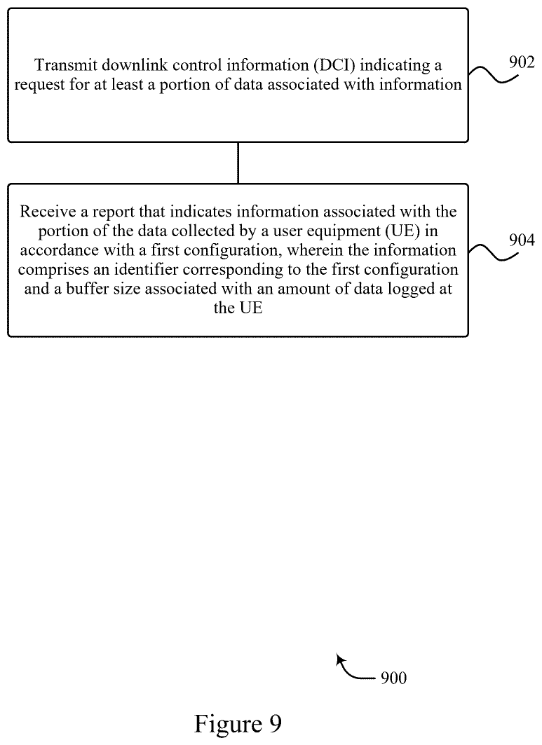

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting DCI indicating a request for at least a portion of the data associated with information. The operations of 902 may be performed in accordance with examples as described herein. In some implementations, aspects of the operations of 902 may be performed by an NA as described with reference to FIG. 7.

At 904, the method may include receiving a report that indicates information associated with the portion of the data collected by a UE in accordance with a first configuration, wherein the information comprises an identifier corresponding to the first configuration and a buffer size associated with an amount of data logged at the UE. The operations of 904 may be performed in accordance with examples as described herein. In some implementations, aspects of the operations of 904 may be performed by an NA as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
generate a report that indicates information associated with data collected in accordance with a first configuration, wherein the information comprises an identifier corresponding to the first configuration and a buffer size associated with an amount of data logged at the UE; and
transmit the report.

2. The UE of claim 1, wherein the at least one processor is configured to cause the UE to:
receive downlink control information (DCI) indicating a request for at least a portion of the data associated with the information in the report, wherein the request includes one or more identifiers corresponding to the portion of the data; and
transmit the portion of the data.

3. The UE of claim 1, wherein the at least one processor is configured to cause the UE to receive a plurality of configurations including the first configuration, each configuration associated with an identifier, and wherein the information comprises a plurality of identifiers corresponding to each of the plurality of configurations and the buffer size associated with an amount of data logged at the UE for each of the plurality of configurations.

4. The UE of claim 1, wherein the report is generated based at least in part on the amount of data collected and logged at the UE satisfying a threshold.

5. The UE of claim 1, wherein the at least one processor is configured to cause the UE to transmit a scheduling request (SR) that requests one or more uplink resources for transmission of the report.

6. The UE of claim 1, wherein the at least one processor is configured to cause the UE to transmit, via an uplink control channel, a one-bit indication that the data is available for transmission.

7. The UE of claim 1, wherein the report is transmitted via a logical channel, and wherein the logical channel is mapped to more than one scheduling request (SR) configuration.

8. The UE of claim 1, wherein the at least one processor is configured to cause the UE to prioritize the information included in the report based at least in part on a priority of each configuration of a plurality of configurations.

9. The UE of claim 8, wherein the information included in the report corresponds to at least one sample of the data based at least in part on a priority of the at least one sample.

10. The UE of claim 1, wherein the first configuration is associated with a plurality of configurations, and wherein the plurality of configurations comprises one or more measurement configurations, one or more measurement logging configurations, one or more reporting configurations, or a combination thereof.

11. The UE of claim 1, wherein the first configuration is associated with a plurality of configurations, and wherein each configuration of the plurality of configurations is associated with a UE-side condition or a network equipment (NE)-side condition.

12. A processor for wireless communication, comprising:
at least one controller coupled with at least one memory and configured to cause the processor to:
generate a report that indicates information associated with data collected in accordance with a first configuration, wherein the information comprises at an identifier corresponding to the first configuration and a buffer size associated with an amount of data logged at a user equipment (UE); and
transmit the report.

13. The processor of claim 12, wherein the at least one controller is configured to cause the processor to:
receive downlink control information (DCI) indicating a request for at least some of the data associated with the information in the report, wherein the request includes one or more identifiers corresponding to the at least some of the data; and
transmit the at least some of the data.

14. The processor of claim 12, wherein the at least one controller is configured to cause the processor to receive a plurality of configurations including the first configuration, each configuration associated with an identifier, and wherein the information comprises a plurality of identifiers corresponding to each of the plurality of configurations and the buffer size associated with an amount of data logged at the UE for each of the plurality of configurations.

15. The processor of claim 12, wherein the report is generated based at least in part on the amount of data collected and logged at the UE satisfying a threshold.

16. The processor of claim 12, wherein the at least one controller is configured to cause the processor to transmit a scheduling request that requests one or more uplink resources for transmission of the report.

17. The processor of claim 12, wherein the at least one controller is configured to cause the processor to transmit, via an uplink control channel, a one-bit indication that the data is available for transmission.

18. The processor of claim 12, wherein the report is transmitted via a logical channel, and wherein the logical channel is mapped to more than one scheduling request configuration.

19. A network entity (NE) for wireless communication, comprising:
at least one memory; and
at least one processor coupled with the at least one memory and configured to cause the NE to:
transmit downlink control information (DCI) indicating a request for at least a portion of data associated with information; and
receive a report that indicates information associated with the portion of the data collected by a user equipment (UE) in accordance with a first configuration, wherein the information comprises an identifier corresponding to the first configuration and a buffer size associated with an amount of data logged at the UE.

20. A method performed by a user equipment (UE), the method comprising:
generating a report that indicates information associated with data collected in accordance with a first configuration, wherein the information comprises an identifier corresponding to the first configuration and a buffer size associated with an amount of data logged at the UE; and
transmitting the report.
